(19) United States
(12) Patent Application Publication
(10) Pub. No.: US 2012/0209608 A1
(43) Pub. Date: Aug. 16, 2012

(54) MOBILE COMMUNICATION TERMINAL APPARATUS AND METHOD FOR EXECUTING APPLICATION THROUGH VOICE RECOGNITION

(75) Inventor: Chang-Dae LEE, Seoul (KR)

(73) Assignee: PANTECH CO., LTD., Seoul (KR)

(21) Appl. No.: 13/248,159

(22) Filed: Sep. 29, 2011

(30) Foreign Application Priority Data
Feb. 15, 2011 (KR) 10-2011-0013257

(51) Int. Cl. G10L 17/00; G10L 21/00

(52) U.S. Cl. 704/246; 704/275; 704/E21.001; 704/E17.003

(57) ABSTRACT

A mobile communication terminal apparatus and method are capable of recognizing an input voice of a user and executing an application related to the recognized voice. The apparatus includes a voice input unit to receive a first input voice; a voice recognition unit to acquire first voice instruction information based on the first input voice; a voice control table acquiring unit to acquire a first voice control table comprising the first voice instruction information and first icon position information; and an application execution unit to execute a first application based on the first icon position information included in the first voice control table. The method for registering voice instruction information includes acquiring voice instruction information for a selected application; acquiring execution information of the selected application; generating a voice control table comprising the execution information, and the voice instruction information; and storing the voice control table.

### CROSS-REFERENCE TO RELATED APPLICATION

This application claims priority from and the benefit under 35 U.S.C. §119(a) of Korean Patent Application No. 10-2011-0013257, filed on Feb. 15, 2011, which is incorporated by reference for all purposes as if fully set forth herein.

### BACKGROUND

1. Field

The following description relates to a mobile communication terminal apparatus and method for executing an application through voice recognition, and more particularly, to a mobile communication terminal apparatus and method capable of recognizing a voice of a user and controlling execution of an application related to the corresponding voice.

2. Discussion of the Background

A mobile communication terminal apparatus, such as a Smart phone, has functions for performing internet communication, searching for information and supporting a computer beyond a simple voice communication function. Therefore, a user may use various types of applications through the mobile communication terminal apparatus.

However, a user may need to search for a desired application among many applications installed on the mobile communication terminal apparatus in order to execute the desired application, and once the desired application is found, may need to perform an additional search or input a command to activate the searched application. For example, if a user tries to search for and execute an application installed on a mobile communication terminal apparatus while driving, the user may have a difficulty in concentrating on driving and may cause a traffic accident. In addition, other users may have some physical impairment that would cause a difficulty in controlling his/her mobile communication terminal apparatus.

Current mobile communication terminal apparatuses may allow some voice interaction, such as voice-activated calling, but it is difficult to control the various applications by use of the voice of a user through the conventional technique.

### SUMMARY

Exemplary embodiments of the present invention provide an apparatus and method for executing an application through voice recognition capable of recognizing an input voice of a user and controlling an execution of an application that is related to the corresponding input voice.

Additional features of the invention will be set forth in the description which follows, and in part will be apparent from the description, or may be learned by practice of the invention.

An exemplary embodiment of the present invention provides an apparatus including a voice input unit to receive a first input voice; a voice recognition unit to acquire first inputted voice instruction information based on the first input voice; a voice control table acquiring unit to acquire a first voice control table including first voice instruction information and first icon position information, the first voice instruction information corresponding to the first inputted voice instruction information; and an application execution unit to execute a first application based on the first icon position information included in the first voice control table.

An exemplary embodiment of the present invention provides a method for registering voice instruction information including acquiring voice instruction information for a selected application; acquiring execution information of the selected application; generating a voice control table including the execution information, and the voice instruction information; and storing the voice control table.

An exemplary embodiment of the present invention provides a method for executing an application by an input voice including acquiring voice instruction information based on the input voice; acquiring a voice control table including the voice instruction information, and execution information of the application; and executing the application based on the execution information.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a mobile communication terminal apparatus capable of executing an application through voice recognition according to an exemplary embodiment of the present invention.

FIG. 2 is a view showing an activation of an application capable of voice control according to an exemplary embodiment of the present invention.

FIG. 3 is a flowchart showing a method for registering voice instruction information of a user for executing an application execution related icon through an input voice of a user according to an exemplary embodiment of the present invention.

FIG. 4 is a flowchart showing a method for executing an application that is related to a voice instruction of a user in the mobile communication terminal apparatus that stores voice control tables including pieces of voice instruction information for the application according to an exemplary embodiment of the present invention.

FIG. 5 is a flowchart showing a method for activating an application through the voice of a user in the mobile communication terminal apparatus according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

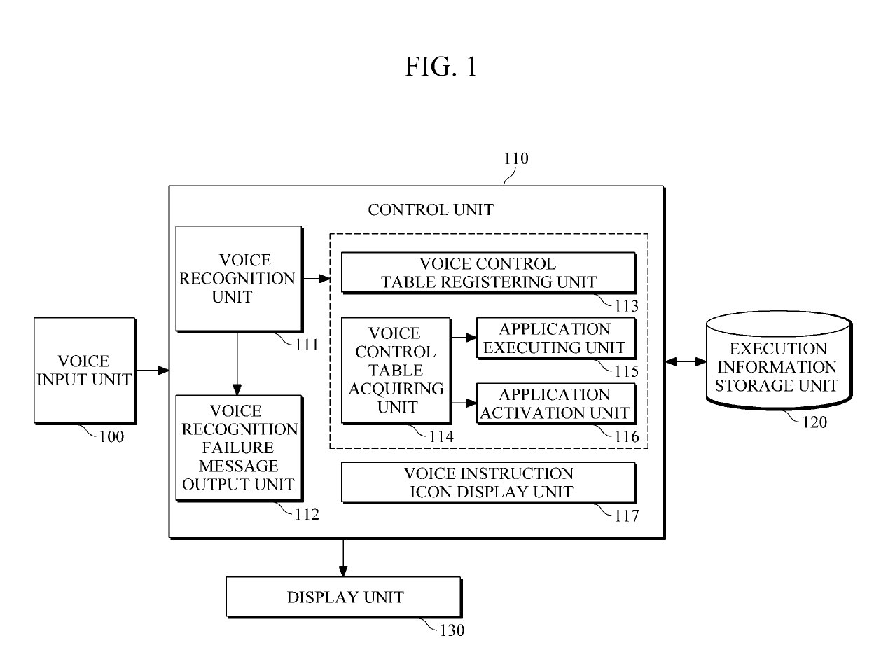

FIG. 1 is a block diagram showing a mobile communication terminal apparatus capable of executing an application through voice recognition according to an exemplary embodiment of the present invention.

As shown in FIG. 1, a mobile communication terminal apparatus includes a voice input unit 100, a control unit 110, and an execution information storage unit 120. The mobile communication terminal apparatus may further include a display unit 130.

The voice input unit 100 receives an input voice such as a voice of a user or a digital audio data. The input voice may be any audio data that can be recognized by voice recognition unit 111. The input voice may include an input voice and an activating input voice. The input voice may be used to register voice instruction information for executing an application or to execute the application. The activating input voice may be used to register activating voice instruction information for activating an activating icon of an application or to activate the activating icon. The execution information registering unit 120 stores a voice control table. The voice control table may include voice instruction information, icon position information, and activation information of an application. The voice instruction information is used for executing an application through an input voice. The voice control table may include voice instruction information used for executing at least one application among multiple applications. The icon position information of an application is position information of an icon which is registered and stored at the registering request of a user. The position information may correspond to a position of the icon on a desktop or screen displayed on the display unit 130 of the mobile communication terminal apparatus. The activation information of an application is identification information of an execution page of an application or identification information of a portion of an application execution process. The execution page may include execution display information which is displayed on a display unit 130 during an execution of an application. Further, execution information for an application may include the icon position information of the icon registered to execute the application. The voice control table may include the execution information.

The control unit 110 recognizes the input voice that is inputted through the voice input unit 100, and controls an application that is related to the recognized input voice to be executed. The control unit 110 may include a voice recognition unit 111, a voice recognition failure message output unit 112, a voice control table acquiring unit 114, and an application execution unit 115. The control unit 110 may further include a voice control table registering unit 113, an application activation unit 116, and a voice instruction icon display unit 117.

For an application capable of execution control through an input voice, the voice recognition unit 111 acquires voice instruction information that is related to the input voice by analyzing the input voice that is inputted through the voice input unit 100. The voice recognition failure message output unit 112 may analyze voice instruction information that is inputted from the voice recognition unit 111 and determines whether voice instruction information related to the input voice is acquired without an error. If it is determined that the voice instruction information is not acquired without an error, the voice recognition failure message output unit 112 generates a voice recognition failure message and displays the generated voice recognition failure message on the display unit 130. For example, if the voice of the user is abnormally received by the voice input unit 100 due to interference such as an external noise, the voice instruction information related to the input voice may not be appropriately acquired. Then, the voice recognition failure message output unit 112 may generate a voice recognition failure message and control the generated voice recognition failure message to be displayed on the display unit 130. Further, the user may input again an input voice related to execution of the corresponding application through the voice input unit 100.

After the voice instruction information related to the input voice is acquired through the voice recognition unit 111, the voice control table acquiring unit 114 acquires a voice control table, which is related to the acquired voice instruction information, from the execution information storage unit 120. In an example, the voice control table acquiring unit 114 acquires the voice control table, having voice instruction information that corresponds to the voice instruction information acquired through the voice recognition unit 111, from the execution information storage unit 120 that stores voice control tables.

For example, if an input voice corresponding to “telephone” is inputted through the voice input unit 100, the voice recognition unit 111 acquires voice instruction information corresponding to “telephone” by analyzing the input voice. Thereafter, the voice control table acquiring unit 114 acquires a voice control table including the voice instruction information corresponding to ‘telephone’ among the stored voice control tables in the execution information storage unit 120. If the voice control table including the voice instruction information corresponding to ‘telephone’ is acquired through the voice control table acquiring unit 114, the application execution unit 115 extracts the icon position information from the voice control table. Then, the application execution unit 115 selects an execution icon of an application among icons displayed on the display unit 130 by using the extracted icon position information. The icon position information indicates position information of an execution icon which is related to the application corresponding to the voice instruction information. If the execution icon is selected, the application execution unit 115 executes the application that is related to the selected execution icon.

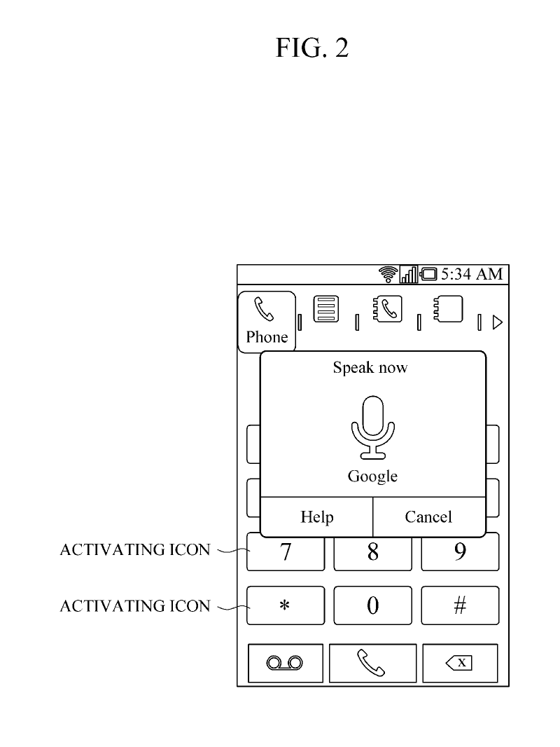

If the application is being executed through the application execution unit 115, the control unit 110 may activate the executed application through the application activation unit 116. That is, while the application is being executed, if activating voice instruction information is acquired through the voice recognition unit 111, the voice control table acquiring unit 114 acquires an activating voice control table including activating icon position information, activation information related to the activation information included in the voice control table, and the activating voice instruction information that corresponds to the activating voice instruction information acquired while the application is being executed. The activation information included in the activating voice control table may be identical to the activation information included in the voice control table. If the activating voice control table including the activating icon position information, the activation information, and the activating voice instruction information is acquired, the application activation unit 116 selects an activating icon based on the activating icon position information. Then, the application activation unit 116 operates the activating icon that is related to the activating icon position information among the activating icons displayed on the display unit 130 during an execution process of the executed application. That is, the application activation unit 116 may operate the activating icon, which is related to the input voice of a user, among activating icons displayed on the display unit 130 during an execution process of the executed application through the application execution unit 115 as shown in FIG. 2. Throughout the specification, ‘activate’ may refer to ‘operate’ or ‘execute’ an activating icon, such as during an execution process of the executed application.

FIG. 2 is a view showing an activation of an application capable of voice control according to an exemplary embodiment of the present invention.

As shown in FIG. 2, if an input voice corresponding to “telephone” is inputted by a user, the voice control table acquiring unit 114 acquires a voice control table that is related to voice instruction information corresponding to “telephone” from the execution information storage unit 120. In an example, the voice control table acquiring unit 114 may acquire a voice control table including voice instruction information corresponding to “telephone”. If the voice control table is acquired, the application execution unit 115 executes an application corresponding to “telephone” by using icon position information of an icon, which is related to ‘telephone’, that is included in the acquired voice control table.

Then, while the application corresponding to “telephone” is being executed, if an activating input voice corresponding to “seven” is inputted from the user, the voice recognition unit 111 acquires activating voice instruction information that is related to the activating input voice “seven”. If the activating voice instruction information corresponding to “seven” is acquired, the voice control table acquiring unit 114 acquires the activation information of the application corresponding to “telephone” from the voice control table acquired based on the voice instruction information “telephone”. Thereafter, the voice control table acquiring unit 114 acquires an activating voice control table that is related to the activating voice instruction information “seven” among stored voice control tables, including activation information of the application corresponding to “telephone”, from the execution information storage unit 120. Accordingly, the activating voice control table including both the activation information of the application corresponding to “telephone” and the activating voice instruction information corresponding to “seven” is acquired. If the activating voice control table is acquired, the application activation unit 116 selects an activating icon based on the activating icon position information included in the activating voice control table. Then, the application activation unit 116 operates the activating icon, ‘seven’, based on the activating icon position information corresponding to “seven” that is included in the acquired activating voice control table. Accordingly, while the application corresponding to “telephone” is being executed, the activating icon corresponding to, “seven”, may be activated among the activating icons. In this manner, by providing a series of activating input voices corresponding to a telephone number of the called party, a telephone number may be dialed using the activating input voices while the “telephone” application is being executed.

Meanwhile, in response to a registering request from a user, the control unit 110 may register an icon of an application, or multiple activating icons, which are displayed during an execution of the corresponding application, through a voice control table registering unit 113 so that the application or the activating icons are able to be controlled by an input voice or activating input voice, respectively. The voice control table registering unit 113 generates a voice control table including activation information of an application which is selected at a registering request of a user, icon position information of an execution icon of the selected application, and voice instruction information acquired through the voice recognition unit 111. The voice control table registering unit 113 also stores the generated voice control table in the execution information storage unit 120.

In an example, if a registering request of an application is inputted by a user and an execution icon of the application is selected, the voice control table registering unit 113 requests an input voice for executing the execution icon, which is related to the execution of the selected application, through a voice. If the input voice is inputted by the user through the voice input unit 100, the voice recognition unit 111 acquires voice instruction information by analyzing the input voice. Thereafter, the voice control table registering unit 113 displays the voice instruction information on the display unit 130 and awaits a user input. That is, the voice control table registering unit 113 makes a request for confirming whether the voice instruction information acquired from the voice recognition unit 111 is desired information. If the voice instruction information is confirmed to be desired by the user through a user input, the voice control table registering unit 113 generates a voice control table including activation information of the selected application, icon position information of the execution icon that is related to execution of the application, and the voice instruction information confirmed by the user. The voice control table registering unit 113 stores the generated voice control table in the execution information storage unit 120. In this manner, the execution information storage unit 120 stores a voice control table of an application that is executable according to the voice instruction of the user.

Meanwhile, the voice control table registering unit 113 may register an activating icon, which is selected at a registering request of a user, among the activating icons displayed on the display unit 130 during an execution of an application and executed through the application execution unit 115 such that the selected activating icon may be executed through voice instruction of the user. That is, at a registering request of an activating icon selected by a user among activating icons displayed on the display unit 130 during an execution of an application, the voice control table registering unit 113 generates an activating voice control table including activation information of the application, activating icon position information of the selected activating icon and activating voice instruction information that is related to the execution of the selected activating icon.

For example, as shown in FIG. 2, while an application corresponding to “telephone” is being executed, if an activating icon corresponding to “seven” is selected at the registering request of a user, the voice control table registering unit 113 displays an image having words “Speak now”. If an activating input voice corresponding to “seven” is inputted by the user, the voice recognition unit 111 acquires activating voice instruction information corresponding to “seven” by analyzing the input voice. Thereafter, the voice control table registering unit 113 makes a request for confirming whether the acquired activating voice instruction information corresponding to “seven” is desired information. If the activating voice instruction information displayed on the display unit 130 is confirmed as desired information by the user, the voice control table registering unit 113 generates an activating voice control table including the activating voice instruction information corresponding to “seven”, activating icon position information of the selected activating icon corresponding to “seven”, and activation information of the “telephone” application. Then, the voice control table registering unit 113 stores the generated activating voice control table in the execution information storage unit 120. Further, the activating icon and the activating voice instruction information may be registered by generating the activating voice control table before the application corresponding to “telephone” is executed, or may be registered according to a default setting that may use voice recognition for recognizing an activating input voice.

Meanwhile, the control unit 111 may convert a registered icon into an icon capable of being controlled by voice instruction among application execution related icons, which is displayed on the display unit 130 through a voice instruction icon display unit 117. Further, the control unit 111 may convert a registered activating icon into an activating icon capable of being controlled by voice instruction among activating icons displayed on the display unit 130 during an execution of the corresponding application. That is, the voice instruction icon display unit 117 converts an icon related to icon position information into an icon that is capable of being controlled by voice instruction among application execution related icons displayed on the display unit 130. The icon position information is included in the voice control table, and the voice control table is stored in the execution information registering unit 120. The voice instruction icon display unit 117 also converts an activating icon related to activating icon position information into an activating icon that is capable of being controlled by voice instruction among activating icons displayed on the display unit 130. The activating icon position information is included in the activating voice control table, and the activating voice control table is stored in the execution information registering unit 120.

In an example, the voice instruction icon display unit 117 may invert a shaded section of an icon capable of being controlled by voice instruction or convert the icon capable of being controlled by voice instruction to be distinguished from an icon that is not capable of being controlled by voice instruction. Likewise, the voice instruction icon display unit 117 may convert an activating icon capable of being controlled by voice instruction. Further, the voice instruction icon display unit 117 may link voice instruction information included in the voice control table to the corresponding icon and display the corresponding icon together with the voice instruction information. Alternatively, the corresponding icon may be displayed differently from the icons not capable of being controlled by voice instruction if the voice instruction information is linked to the corresponding icon. Accordingly, the user may recognize an application execution related icon for which voice instruction information is registered and stored. Further, the user may recognize an activating icon for which voice instruction information is registered and stored among activating icons displayed on the display unit 130 during an execution of the application.

The icon may be referred to as “execution icon”, “execution related icon”, “application execution related icon”, or the like. The icon is used for executing an application. On the other hand, the activating icon may be used for activating or operating a portion of a process of the application during the execution of the application. However, if the activating icon is operated by activating voice instruction information before executing an application, the mobile communication terminal apparatus may execute the application before operating the activating icon. In this instance, a voice control table and an activating control table may be acquired to retrieve relevant information.

For example, if an activating voice instruction information corresponding to “seven”, is acquired from an activating input voice before executing an application, the mobile communication terminal apparatus may acquire one or more activating voice control tables including activating voice instruction information, “seven”. If the mobile communication terminal apparatus acquires only one activating voice control table, the mobile communication terminal apparatus retrieves activation information, which is related to “telephone”, included in the acquired activating voice control table. Then, the mobile communication terminal apparatus acquires the voice control table having activation information related to the retrieved activation information of the activating voice control table. The mobile communication terminal apparatus may first execute an application, “telephone”, based on the voice control table, and then operate the activating icon, “seven”, based on the activating voice control table.

If the mobile communication terminal apparatus acquires more than one activating voice control table, the mobile communication terminal apparatus retrieves activation information included in the acquired activating voice control tables, respectively. Then, the mobile communication terminal apparatus outputs the retrieved activation information included in the acquired activating voice control tables. A user may input an input voice in response to the outputted activation information. If the mobile communication terminal apparatus receives the input voice, “telephone”, from the user, the mobile communication terminal apparatus acquires voice instruction information, “telephone”, from the input voice. Then, the mobile communication terminal apparatus acquires the voice control table having the voice instruction information, “telephone”, and selects an activating voice control table having activation information related to activation information of the acquired voice control table among the acquired activating voice control tables. The mobile communication terminal apparatus executes an application, “telephone”, based on the voice control table, and operates the activating icon, “seven”, based on the selected activating voice control table.

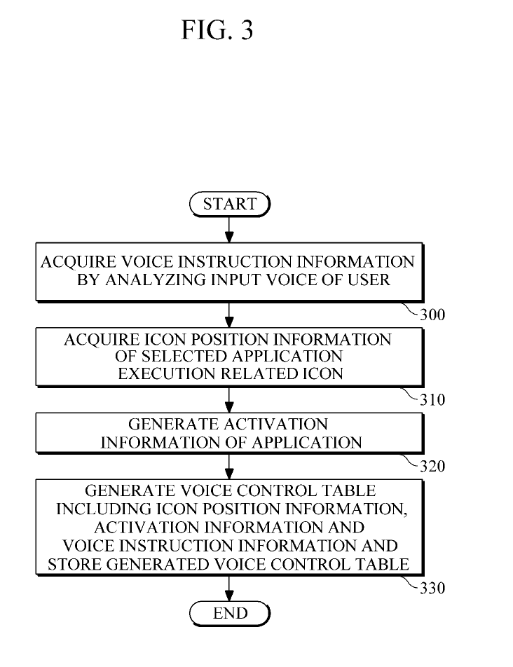

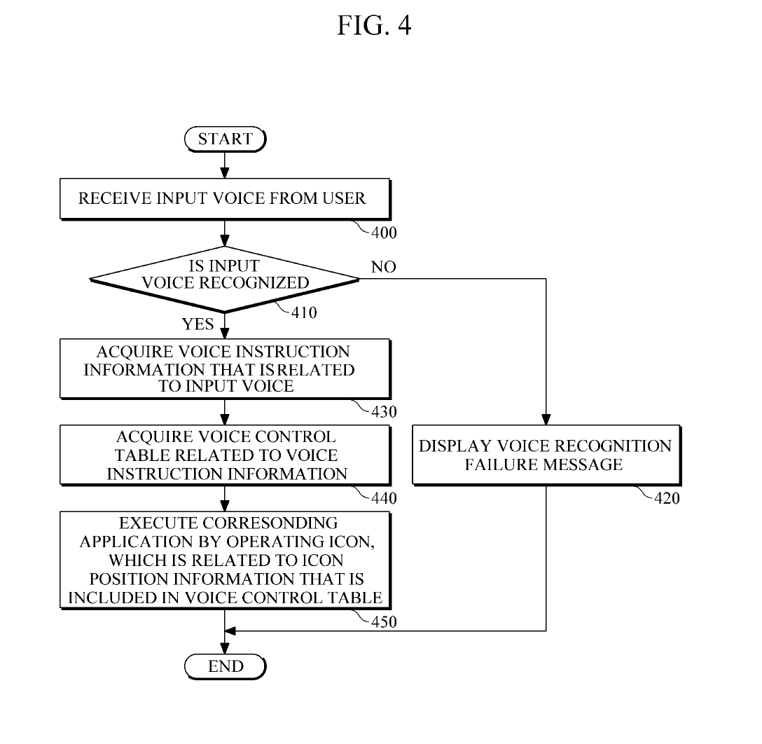

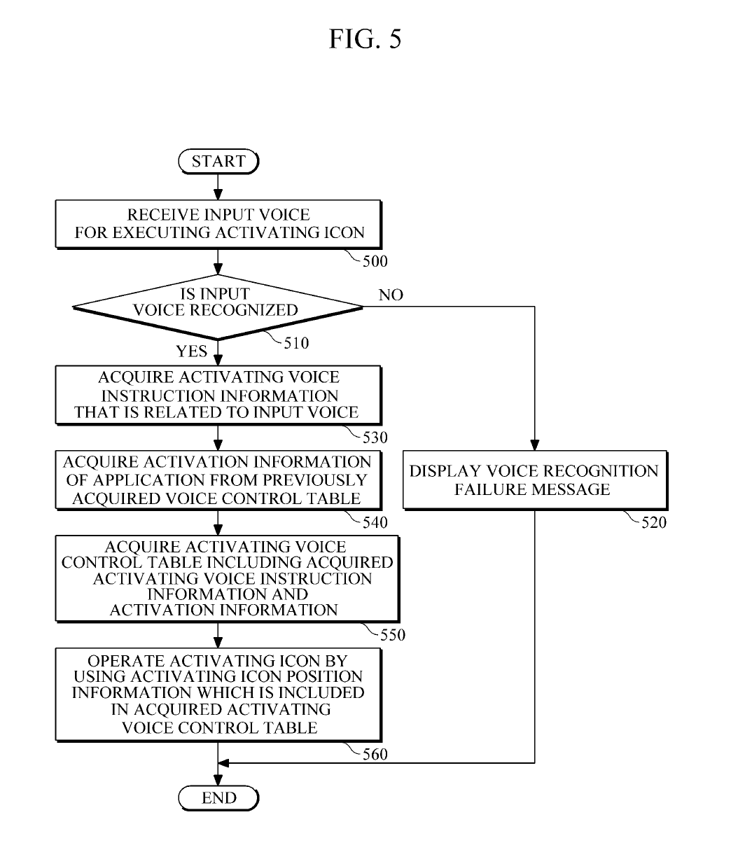

The above description has been made in relation to the configuration of the mobile communication terminal apparatus to execute an application according to the voice recognition. Hereinafter, a method for registering voice instruction information of a user to execute an application through the input voice of a user in the mobile communication terminal apparatus and a method for executing the corresponding application according to the registered voice instruction information of the user will be described in more detail. For ease of description, FIG. 3, FIG. 4, and FIG. 5 will be described as if the method is performed by the above-described mobile communication terminal apparatus. However, the method is not limited as such.

FIG. 3 is a flowchart showing a method for registering voice instruction information of a user for executing an application execution related icon through an input voice of a user according to an exemplary embodiment of the present invention.

The application execution related icon may be displayed on a mobile communication terminal. As shown in FIG. 3, a mobile communication terminal apparatus acquires voice instruction information by analyzing the input voice of a user (300). The input voice of a user is inputted for an application execution related icon that is selected at a registering request of the user among application execution related icons displayed on the mobile communication terminal apparatus. That is, if an application execution related icon is selected at a registering request of a user, the mobile communication terminal apparatus makes a request for inputting an input voice such that the corresponding application is controlled by the input voice. If the input voice that is related to the corresponding application execution related icon is inputted by the user, the mobile communication terminal apparatus acquires voice instruction information by analyzing the input voice. Thereafter, the mobile communication terminal apparatus may make a request for confirming whether the acquired voice instruction information is desired information. If the voice instruction information is confirmed as desired information, the mobile communication terminal apparatus acquires icon position information of the selected application execution related icon (310). That is, the mobile communication terminal apparatus stores icon position information in the mobile communication terminal apparatus. The icon position information indicates the display position of each application execution related icon used for executing the corresponding applications, and includes execution related information. Accordingly, if at least one icon is selected from the application execution related icons by a user, the mobile communication terminal apparatus acquires icon position information of the selected icon among pieces of icon position information that are stored in the mobile communication terminal apparatus. If the icon position information of the selected application execution related icon is acquired, the mobile communication terminal apparatus generates activation information of the selected application (320). The activation information may be identification information of an execution page of the application, and the execution page is displayed on the mobile terminal apparatus during an execution of the application as the selected application execution related icon is executed according to the voice instruction of the user. If the activation information is generated, the mobile communication terminal apparatus generates a voice control table including the voice instruction information, the icon position information of the selected application execution related icon, and the activation information of the application, and stores the generated voice control table (330).

For example, at a registering request of a user, if an icon that is related to an application of “telephone” is selected from among application execution related icons that are displayed on an mobile communication terminal apparatus, the mobile communication terminal apparatus makes a request for inputting the voice of a user such that the application of “telephone” is executed through voice control. If the voice corresponding to “telephone” is inputted by the user, the mobile communication terminal apparatus acquires voice instruction information corresponding to the voice “telephone” by analyzing the input voice, and makes a request for confirming whether the acquired voice instruction information is desired information. At the request for confirming, if the acquired voice instruction information is confirmed by the user, the mobile communication terminal apparatus acquires icon position information of the icon that is related to the selected application “telephone” among application execution related icons that are stored in the mobile communication terminal apparatus. Thereafter, the mobile communication terminal apparatus generates activation information, which represents identification information of an execution page of the application “telephone” that is executed according the voice instruction of the user. Then, the mobile communication terminal apparatus generates a voice control table including the voice instruction information related to the voice corresponding to “telephone”, the icon position information of the application execution related icon related to ‘telephone’ and the activation information of the application execution related icon related to ‘telephone’, and stores the generated voice control table. In this manner, the voice control table used to execute the ‘telephone’ application through user voice is stored in the mobile communication terminal apparatus. Further, although not shown, if a user moves an icon that is stored in a voice control table, such as by a drag-and-drop action, the icon position information stored in the corresponding voice control table may be updated to correspond to the new icon position.

The above description has been made in relation to a method for registering the voice instruction information of a user such that an application execution related icon is executed through the voice of the user. Hereinafter, a method for executing a corresponding application according to the voice control table that is stored to correspond to the received voice information will be described in more detail.

FIG. 4 is a flowchart showing a method for executing an application that is related to a voice instruction of a user in the mobile communication terminal apparatus that stores voice control tables including pieces of voice instruction information for the application according to an exemplary embodiment of the present invention.

As shown in FIG. 4, the mobile communication terminal apparatus receives an input voice, which is related to an application from a user (400). If the input voice is inputted by the user, the mobile communication terminal apparatus determines whether the input voice is recognized (410). If the input voice is not recognized, a voice recognition failure message is generated and displayed on the mobile communication terminal apparatus (420). If the input voice is recognized, the mobile communication terminal apparatus acquires voice instruction information that is related to the input voice (430). The mobile communication terminal apparatus having acquired the voice instruction information retrieves a voice control table that is related to the acquired voice instruction information from an execution information storage unit 120 that stores voice control tables including voice instruction information for each application (440). Then, the mobile communication terminal apparatus executes the application related to the input voice by operating an icon that is related to icon position information, which is included in the acquired voice control table (450).

Hereinafter, a method for activating the application that is executed through the voice instruction of the user is described with reference to FIG. 5.

FIG. 5 is a flowchart showing a method for activating an application through the voice of a user in the mobile communication terminal apparatus according to an exemplary embodiment of the present invention.

As shown in FIG. 5, the mobile communication terminal apparatus receives an input voice for executing an activating icon among multiple available activating icons during an execution of an application (500). If the input voice, which is related to execution of the activating icon used to activate an application, is inputted, the mobile communication terminal apparatus determines whether the input voice is recognized (510). If it is determined that the input voice is not recognized, a voice recognition failure message is displayed on the mobile communication terminal apparatus (520). If it is determined that the input voice is recognized, the mobile communication terminal apparatus analyzes the input voice, and acquires activating voice instruction information related to the input voice (530). If the activating voice instruction information is acquired, the mobile communication terminal apparatus acquires activation information, which represents identification information of an execution page of an application, from a voice control table that is previously acquired to execute the application (540). If the activation information is acquired, the mobile communication terminal apparatus acquires an activating voice control table, which includes the acquired activation information and the acquired activating voice instruction information, among voice control tables that are stored in the mobile communication terminal apparatus (550).

That is, the mobile communication terminal apparatus acquires an activating voice control table, which includes the acquired activation information of the application, among activating voice control tables that are stored in the mobile communication terminal apparatus. For example, if an application “telephone” is executed, dial key pad related icons used to input phone numbers are displayed on the execution page during the execution of the application “telephone”. The mobile communication terminal apparatus stores activating voice control tables each including the activation information of the “telephone” application and each piece of activating voice instruction information of the dial key pad related icons. Accordingly, the mobile communication terminal apparatus may acquire activating voice control tables including the activation information (related to “telephone”) from the mobile communication terminal apparatus. After the activating voice control tables are acquired, the mobile communication terminal apparatus acquires an activating voice control table including the activating voice instruction information, which is acquired in operation 530, among the activating voice control tables. If the activating voice control table including the activating voice instruction information and the activation information is acquired, the terminal communication terminal apparatus operates an activating icon by using activating icon position information of the activating icon, which is included in the acquired activating voice control table and used to activate the corresponding application (560). In this manner, the mobile communication terminal apparatus operates an activating icon that is related to an input voice inputted by a user among multiple available activating icons during an execution of an application, thereby activating the application.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus, comprising:
a voice input unit to receive a first input voice;
a voice recognition unit to acquire first inputted voice instruction information based on the first input voice;
a voice control table acquiring unit to acquire a first voice control table comprising the first voice instruction information and first icon position information, the first voice instruction information corresponding to the first inputted voice instruction information; and
an application execution unit to execute a first application based on the first icon position information included in the first voice control table.

2. The apparatus of claim 1, further comprising:
an execution information storage unit to store the first voice control table comprising the first voice instruction information to execute the first application, the first icon position information, and first activation information having identification information of the first application, and to store a first activating voice control table comprising first activating voice instruction information to execute a first activating icon of the first application, first activating icon position information, and the first activation information; and
an application activation unit to operate the first activating icon based on the first activating icon position information.

3. The apparatus of claim 1, further comprising:
a voice control table registering unit to generate a second voice control table comprising second icon position information of a second icon corresponding to a second application, second voice instruction information to control the second application and second activation information, and to store the second voice control table in an execution information storage unit.

4. The apparatus of claim 1, wherein the first voice control table further comprises first activation information,
the voice input unit further receives a first activating input voice during an execution of the first application,
the voice recognition unit acquires first activating voice instruction information based on the first activating input voice,
the voice control table acquiring unit acquires a first activating voice control table comprising the first activating voice instruction information, first activating icon position information of a first activating icon of the first application, and the first activation information,
the application activation unit operates the first activating icon based on the first activating icon position information.

5. The apparatus of claim 3, further comprising:
a voice instruction icon display unit to convert an icon that is related to execution of the second application into the second icon capable of being controlled by the second voice instruction information, and to convert an activating icon into an activating icon capable of being controlled by activating voice instruction information.

6. The apparatus of claim 1, further comprising:
a voice recognition failure message output unit to output a voice recognition failure message, which indicates an acquisition failure of the first inputted voice instruction information or indicates an acquisition failure of an activating voice instruction information.

7. The apparatus of claim 3, wherein the voice control table registering unit generates a second activating voice control table comprising second activating voice instruction information, second activating icon position information of an activating icon, and the second activation information, and stores the second activating voice control table in the execution information storage unit.

8. The apparatus of claim 7, wherein the second voice control table further comprises third activation information which is linked with the second activation information.

9. A method for registering voice instruction information, comprising:
acquiring voice instruction information for a selected application;
acquiring execution information of the selected application;
generating a voice control table comprising the execution information, and the voice instruction information; and
storing the voice control table.

10. The method of claim 9, further comprising:
generating activation information comprising identification information of the selected application,
wherein the voice control table further comprises the activation information, and
the execution information comprises icon position information of an icon for executing the selected application.

11. The method of claim 10, further comprising:
acquiring activating voice instruction information for the selected application;
generating an activating voice control table comprising activating icon position information of an activating icon for executing the activating icon, the activating voice instruction information, and the activation information; and
storing the activating voice control table.

12. The method of claim 9, further comprising:
receiving an input voice,
wherein the voice instruction information is acquired based on the input voice.

13. The method of claim 10, further comprising:
converting the icon that is related to execution of the selected application into an icon capable of being controlled by the voice instruction information.

14. The method of claim 10, further comprising: outputting a voice recognition failure message, which indicates an acquisition failure of the voice instruction information.

15. A method for executing an application by an input voice, comprising:
acquiring voice instruction information based on the input voice;
acquiring a voice control table comprising the voice instruction information and execution information of the application; and
executing the application based on the execution information.

16. The method of claim 15, further comprising:
generating a voice recognition failure message, which indicates an acquisition failure of the voice instruction information; and
outputting the voice recognition failure message.

17. The method of claim 15, further comprising:
acquiring activating voice instruction information;
acquiring activation information comprising identification information of the application from the voice control table;
acquiring an activating voice control table comprising activating icon position information of an activating icon for executing the activating icon, the activating voice instruction information, and the activation information; and
operating the activating icon based on the activating icon position information.

18. The method of claim 16, wherein the voice recognition failure message is generated if the voice instruction information or the activating voice instruction information is not acquired without an error.

19. The method of claim 17, wherein if the activating voice instruction information is acquired during an execution of the application, the activating icon is operated during the execution of the application,
if the activating voice instruction information is acquired before executing the application, the activating icon is operated after executing the application based on the execution information of the voice control table.

20. The method of claim 15, wherein the execution information comprises icon position information of an icon for executing the application.
